(19) United States
(12) Patent Application Publication
(10) Pub. No.: US 2017/0092205 A1
(43) Pub. Date: Mar. 30, 2017

(54) MEMS ACTUATOR BEAM WITH INSULATOR TABS

(71) Applicant: Pixtronix, Inc., San Diego, CA (US)

(72) Inventors: Chin-Yuan Ho, Chupei (TW); Javier Villarreal, Somerville, MA (US); Hung-Chien Lin, Hsinchu (TW)

(21) Appl. No.: 14/864,409

(22) Filed: Sep. 24, 2015

(51) Int. Cl. G09G 3/34

(52) U.S. Cl. CPC G09G 3/3433

(57) ABSTRACT

This disclosure provides systems, methods, and apparatus for providing protective coatings on electromechanical systems (EMS) devices. A display apparatus can include an electrostatic actuation assembly for controlling the position of a suspended portion of a display element. The electrostatic actuation assembly can include a load beam, drive beam, and a coating disposed over a portion of the drive beam. The coating can include a plurality of raised tabs spaced apart from each other. One or both of the size of the raised tabs and a pitch between raised tabs can be varied along a surface of the drive beam. The voltage used to actuate the actuator is, in part, related to the shape and relative position of the load and drive beams. The raised tabs can be sized, spaced, or positioned to affect a desired rest position and rest shape of the drive beam relative to the load beam.

### TECHNICAL FIELD

This disclosure relates to electromechanical systems (EMS), and in particular, to providing particular patterned configurations of protective coatings for EMS devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, or a combination of these or other micromachining processes that etch away parts of substrates, the deposited material layers, or both. Such processes also may be used to add layers to form electrical and electromechanical devices.

Display devices can include an array of electromechanical systems (EMS) shutter assemblies. Each shutter assembly includes a suspended portion such as a shutter that is positioned over an aperture and an actuator for moving the shutter into open and closed positions over or adjacent to the aperture. The actuators include a drive beam positioned near a load beam that is attached to the shutter. By providing electrical potential to either or both of the drive beam and the load beam, electrostatic forces are generated between the drive beam and the load beam. These electrostatic forces attract the load beam towards the drive beam. The motion of the load beam towards the drive beam also moves the shutter with respect to the aperture.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus including an electrostatic actuation assembly for controlling a position of a suspended portion of a display element. The electrostatic actuation assembly includes a load beam, a drive beam, and a coating disposed over at least a portion of the drive beam. The coating includes a plurality of raised tabs spaced apart from each other. At least one of a size of the raised tabs and a pitch between the raised tabs varies along a surface of the drive beam.

In some implementations, the size of the plurality of raised tabs varies along the surface of the drive beam such that a size of a first raised tab is different from a size of a second raised tab. In some implementations, the pitch between each adjacent pair of the plurality of raised tabs is constant. In some implementations, the size of the plurality of raised tabs monotonically increases along the surface of the drive beam. In some implementations, the size of the plurality of raised tabs increases along the surface of the drive beam such that the size of each raised tab positioned nearer a first end of the drive beam is smaller than the size of each successive raised tab positioned nearer a second end of the drive beam.

In some implementations, the pitch between the plurality of raised tabs varies along the surface of the drive beam such that a space between a first raised tab and a second raised tab is different from a space between the second raised tab and a third raised tab. In some implementations, each raised tab of the plurality of raised tabs has a common size. In some implementations, the pitch between the plurality of raised tabs increases along the surface of the drive beam such that a distance between a pair of raised tabs positioned nearer a first end of the drive beam is smaller than a distance between each successive pair of raised tabs positioned nearer a second end of the drive beam. In some implementations, the pitch between the plurality of raised tabs monotonically increases along the surface of the drive beam.

In some implementations, the coating includes a dielectric material. In some implementations, the load beam is coupled to a light modulator and to a first anchor, the drive beam is coupled to a second anchor, and the plurality of raised tabs includes a raised tab that coats a curve of the drive beam at a point where the drive beam curves toward the second anchor. In some implementations, the drive beam includes a concave portion and a raised tab within the concave portion. In some implementations, the drive beam is a loop having a first surface that is a surface of the drive beam nearest the load beam and a second surface that is a surface at an opposite side of loop from the first surface, and the plurality of raised tabs are coupled to both the first surface and the second surface. In some implementations, the first surface includes a different number of raised tabs than the second surface. In some implementations, the size of the raised tabs increases from an anchor end of the drive beam to a distal end of the drive beam, and the pitch between adjacent pairs of raised tabs increases from the distal end of the drive beam to the anchor end of the drive beam.

In some implementations, the apparatus includes a display having the display element, a processor that is capable of communicating with the display and processing image data, and a memory device that is capable of communicating with the processor. In some implementations, the display includes a driver circuit capable of sending at least one signal to the display, and a controller capable of sending at least a portion of the image data to the driver circuit. In some implementations, the display includes an image source module that includes an image source module having at least one of a receiver, transceiver, and transmitter and is capable of sending the image data to the processor, and an input device capable of receiving input data and to communicate the input data to the processor.

Another innovative aspect of the subject matter described in this disclosure can be implemented in a method for forming an electrostatic actuator. The method includes forming a mold on a substrate, the mold including a first wall and a second wall opposing the first wall. The method further includes depositing a structural material on the first wall and the second wall, depositing a coating over at least a portion of the structural material, and patterning at least a portion of the coating to form a plurality of raised tabs that are spaced apart from each other. At least one of a size of the plurality of raised tabs and a pitch between the plurality of raised tabs varies along a surface of the drive beam. The method also includes patterning the structural material to form a load beam and a drive beam opposing the load beam such that the plurality of raised tabs are located at least on the drive beam, and releasing the load beam and the drive beam from the mold.

In some implementations, patterning the coating includes creating raised tabs having sizes that vary along the surface of the drive beam such that a size of a first raised tab is different from a size of a second raised tab. In some implementations, the pitch between each adjacent pair of the plurality of raised tabs is substantially the same. In some implementations, the size of the plurality of raised tabs increases along the surface of the drive beam such that the size of each raised tab positioned nearer a first end of the drive beam is smaller than the size of each successive raised tab positioned nearer a second end of the drive beam. In some implementations, patterning the coating includes creating raised tabs having sizes that monotonically increase along the surface of the drive beam.

In some implementations, patterning the coating includes removing portions of the coating to create pairs of raised tabs have pitches that vary along the surface of the drive beam such that a distance between a first raised tab and a second raised tab is different from a distance between the second raised tab and a third raised tab. In some implementations, the pitch between the plurality of raised tabs increases along the surface of the drive beam such that a pitch between a pair of raised tabs positioned nearer a first end of the drive beam is smaller than a pitch between each successive pair of raised tabs positioned nearer a second end of the drive beam. In some implementations, each raised tab of the plurality of raised tabs has a common size. In some implementations, patterning the coating includes creating pairs of adjacent raised tabs having pitches between adjacent raised that that monotonically increase in size along the surface of the drive beam.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 shows an example shutter assembly during a manufacturing stage.

FIGS. 4A and 4B show top views of portions of various example electrostatic actuation assemblies having raised tab areas of different sizes.

FIGS. 5A and 5B show top views of portions of various example electrostatic actuation assemblies having raised tabs of different sizes.

FIGS. 6A and 6B show top views of portions of various example electrostatic actuation assemblies having a varying pitch size between raised tabs.

FIG. 7 shows a top view of a portion of an example electrostatic actuation assembly having a raised tab at a curve of a drive beam.

FIG. 8 shows a top view of a portion of an example electrostatic actuation assembly having a raised tab within a concave portion of a drive beam.

FIG. 9A shows a graph of experimental data showing a relationship between tip gap size and difference in size between adjacent raised tabs.

FIG. 9B shows a graph of experimental data showing a relationship between tip gap size and difference in pitch size between adjacent pairs of raised tabs.

FIG. 10 shows a graph of experimental data showing a relationship between tip gap size and size of a raised tab connected to an anchor.

FIG. 11 shows an example flow diagram of a process for providing a coating over one or more portions of a shutter assembly.

FIGS. 12A-12F show cross sectional and isometric views of stages of construction of another example shutter assembly.

FIGS. 13A and 13B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A display apparatus can include a plurality of EMS devices, responsive to image data, for rendering images. The display apparatus can employ a MEMS shutter-based assembly that includes at least one actuator having a compliant drive beam and a compliant load beam. The voltage used to actuate the actuator is a function, in part, of the shape and relative position of the load and drive beams. Implementations in which there are greater distances between the load and drive beams normally require higher actuation voltages than implementations where there are smaller distances between the load and drive beams.

During a typical manufacturing process, the material forming the aforementioned shutter assemblies is deposited over a sacrificial mold. A coating is deposited over all exposed surfaces of the shutter assembly to help prevent shorts forming between the actuator beams. The coating, which is typically a dielectric, contributes to the relative shape and position of one or both of the load and drive beams.

Material stresses resulting from the deposition of the materials used to form the compliant drive beam and the compliant load beam along with their respective coatings can bias the rest positions and rest shapes of the beams (i.e., the shape and position of the beams when no voltage is applied). In turn, the voltage necessary to actuate the actuator (known as the actuation voltage) can be affected by the rest position and rest shape of the beams. Accordingly, the actuation voltage depends, in part, on characteristics of a coating applied to the beams. The actuation voltage can be adjusted by removing or retaining the coating on the beams in desired places and positions to adjust the mechanical stresses on the beams. The actuation voltage can be manipulated by modifying the location and configuration of the coating on the surfaces of the load and drive beams.

In some implementations, the coating is patterned so that portions of it will be removed to modify one or both of the shape and position of the drive beam. For example, the coating can be patterned into a plurality of raised tabs having gaps therebetween. The plurality of raised tabs also may be referred to as raised segments or ridges. The plurality of raised tabs are sized, spaced, and positioned to affect a desired rest position and rest shape of the drive beam relative to the load beam. In some implementations, the plurality of raised tabs are sized and spaced such that the sizes of raised tabs vary along the surface of the drive beam. In some implementations, a pitch or distance between raised tabs varies along the surface of the drive beam. In some implementations, the desired rest position and rest shape allows a tip gap between the drive beam and the load beam to be reduced, thereby decreasing the electrostatic force, and consequently the actuation voltage, used to actuate the actuator.

Particular implementations of the subject matter described in this disclosure can be implemented to realize one or more of the following potential advantages. The deposition and patterning of a coating over the shutter assembly, results in actuator beams having one or both of a desired rest position and rest shape that decreases the gap between the load and drive beams. This rest position and shape can reduce the actuation voltage necessary for actuating the actuator. As such, power savings is achieved while maintaining shutter speed and yield.

In addition, providing the coating on the shutter assembly prior to releasing the shutter assembly from the mold provides a uniform and thicker coating near the tip gap which may enable more uniform driving conditions and fewer breakdown issues. However, providing the coating on the shutter assembly prior to releasing the shutter assembly from the mold also may make it more difficult to control the rest position of the load and drive beams. By patterning the coating, this rest position can be controlled more effectively.

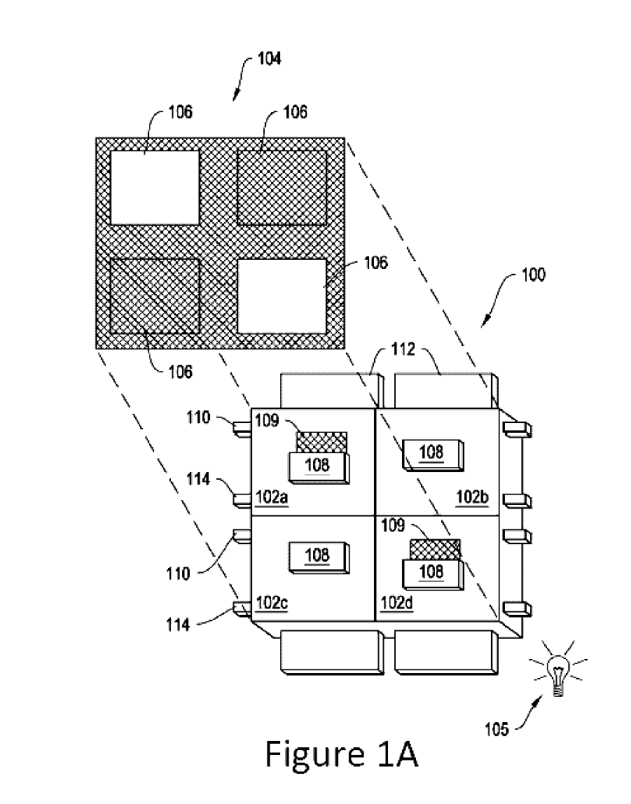

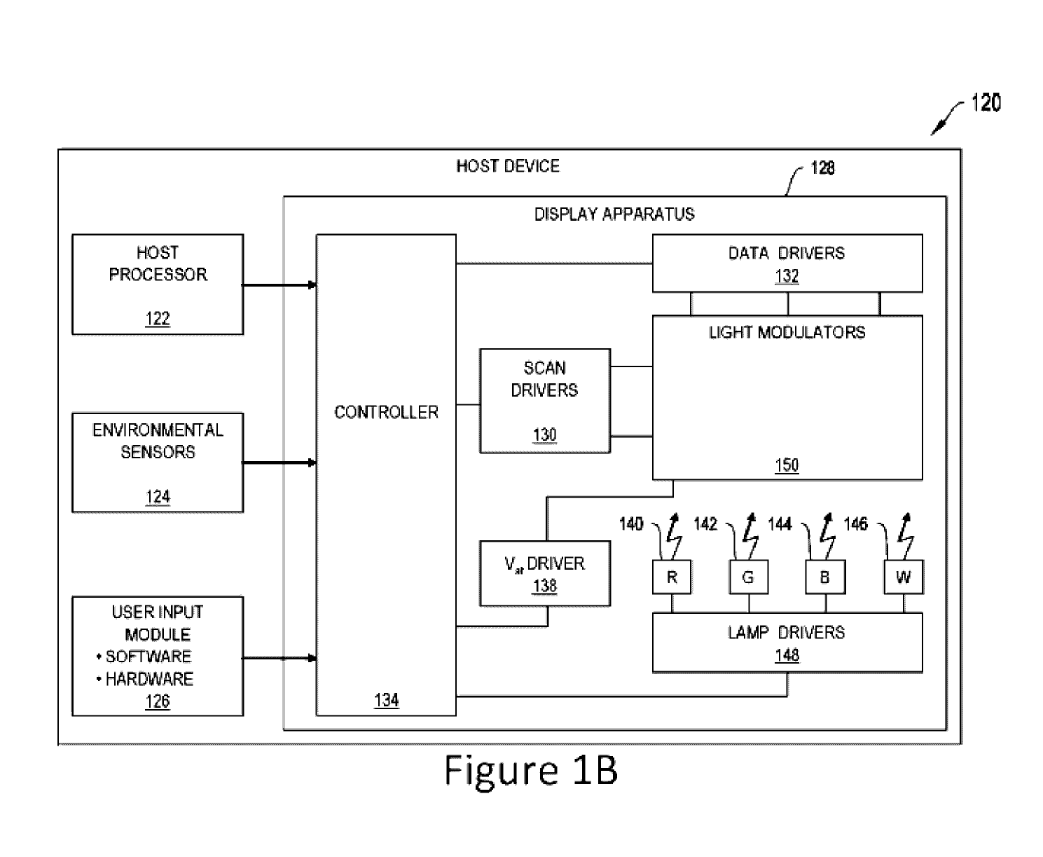

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing one or both of brightness and contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of one or both of driving and initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

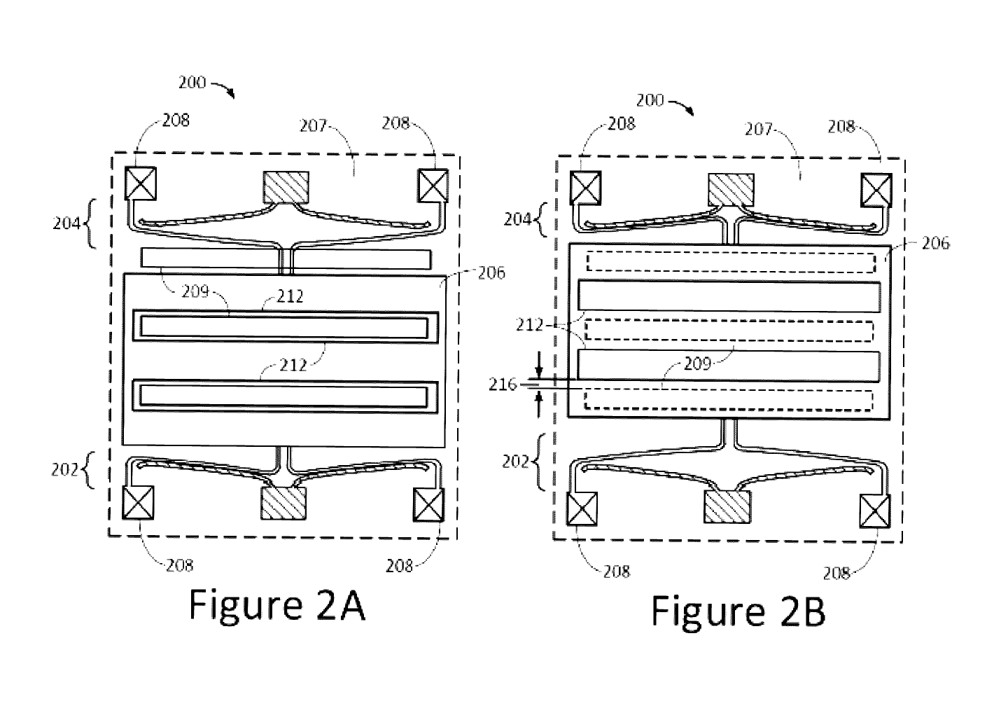

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

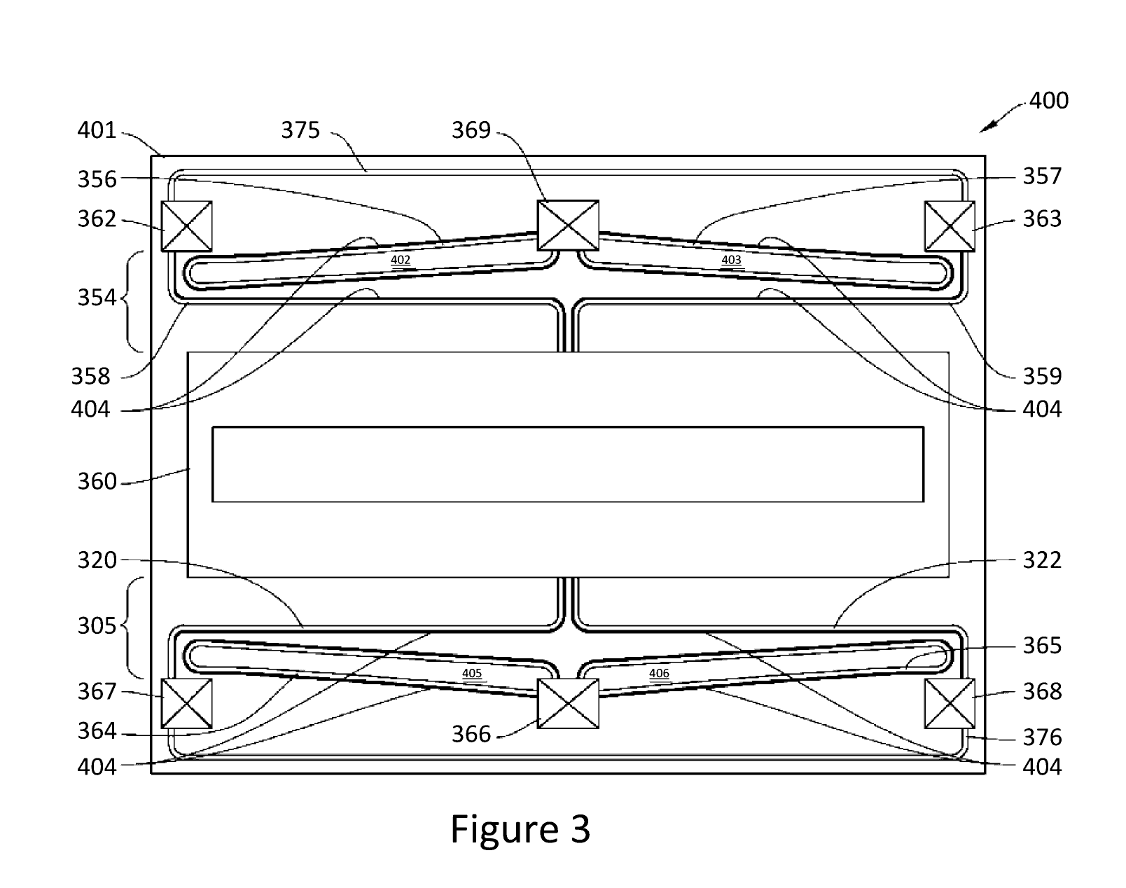

FIG. 3 shows a view of a shutter assembly 400 during a manufacturing stage. The shutter assembly 400 includes a mold 401 on which the shutter assembly 400 has been formed. The shutter assembly 400 includes a shutter 360 and two actuator assemblies: a first actuator assembly 354, and a second actuator assembly 305.

The first actuator assembly 354 includes a first looped drive beam 356 and a second looped drive beam 357. The first looped drive beam 356 and the second looped drive beam 357 are formed around the sidewalls of a first raised mold portion 402 and a second raised mold portion 403 of the mold 401, and which are attached to a first drive anchor 369. The first and second looped drive beams 356 and 357 each include two primary surfaces, one of which is coated with a dielectric material 404 and one of which is in contact with the mold 401 and is not coated with the dielectric material 404. The dielectric material 404 is shown as extending across an entirety of a first surface of the first and second looped drive beams 356 and 357. In some implementations, the dielectric material 404 may be patterned to define desired shapes, sizes, and patterns of raised tabs of the dielectric material 404. The first actuator assembly 354 also includes a first load beam 358 and a second load beam 359. A first end of both the first and second load beams 358 and 359 is attached to the shutter 360. The other end of the first load beam 358 is attached to a first load anchor 362. The other end of the second load beam 359 is attached to a second load anchor 363. The first and second load beams 358 and 359 also have two primary surfaces, one of which is coated with the dielectric material 404 and one of which is in contact with the mold 401 and is not coated with the dielectric material 404. In some implementations, there may be no dielectric material 404 on the first and second load beams 358 and 359.

The first actuator assembly 354 also includes a first peripheral beam 375 attached to the first load anchor 362 and the second load anchor 363. The first peripheral beam 375 and the first and second load beams 358 and 359 are formed on the sidewalls of an enclosed space of the mold 401. In contrast to the first and second looped drive beams 356 and 357, which are formed on the outer sidewalls of the first and second raised mold portions 402 and 403, the first peripheral beam 375 and the first and second load beams 358 and 359 are formed on the inside of a wall that encloses a lower portion of the mold 401 that surrounds the first and second raised portions 402 and 403. The first peripheral beam 375 and the first and second load beams 358 and 389 together form a loop along the boundary of the enclosed space.

The second actuator assembly 305 also includes a third looped drive beam 364 and a fourth looped drive beam 365 attached to a drive anchor 366. The third and fourth looped drive beams 364 and 365 are formed around sidewalls of a third raised mold portion 405 and a fourth raised portion 406 of the sacrificial mold 401, respectively. The second actuator assembly 305 also includes a third load beam 320 and a fourth load beam 322 that are each attached to the shutter 360 and a third load anchor 367 and a fourth load anchor 368, respectively. The dielectric material 404 is formed on a surface of each of the third and fourth drive beams 364 and 365 and the third and fourth load beams 320 and 322. The third and fourth looped drive beams 364 and 365 and the third and fourth load beams 320 and 322 each also have two primary surfaces, one of which is coated with the dielectric material 404 and one of which is in contact with the mold 401 and is not coated with the dielectric material 404. In additional implementations, the dielectric material 404 may be patterned on the third and fourth drive beams 364 and 365 and there may be no dielectric material 404 on the third and fourth load beams 320 and 322. The second actuator assembly 305 also includes a second peripheral beam 376 attached to the third and fourth load anchors 367 and 368. Like the first and second load beams 358 and 359 and the first peripheral beam 375, the second peripheral beam 376 and the third and fourth load beams 320 and 322 together also form a loop around an enclosed space of the mold 401. In particular, the second peripheral beam 376 and the third and fourth load beams 320 and 322 are formed on the inside of a wall that encloses the lower portion of the mold that surrounds the third and fourth raised portions 405 and 406.

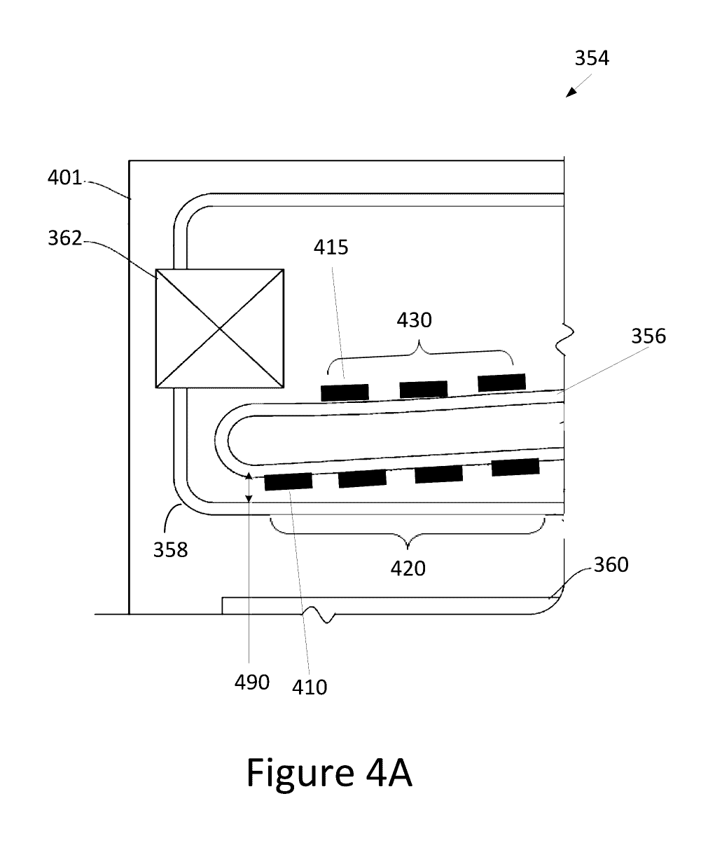

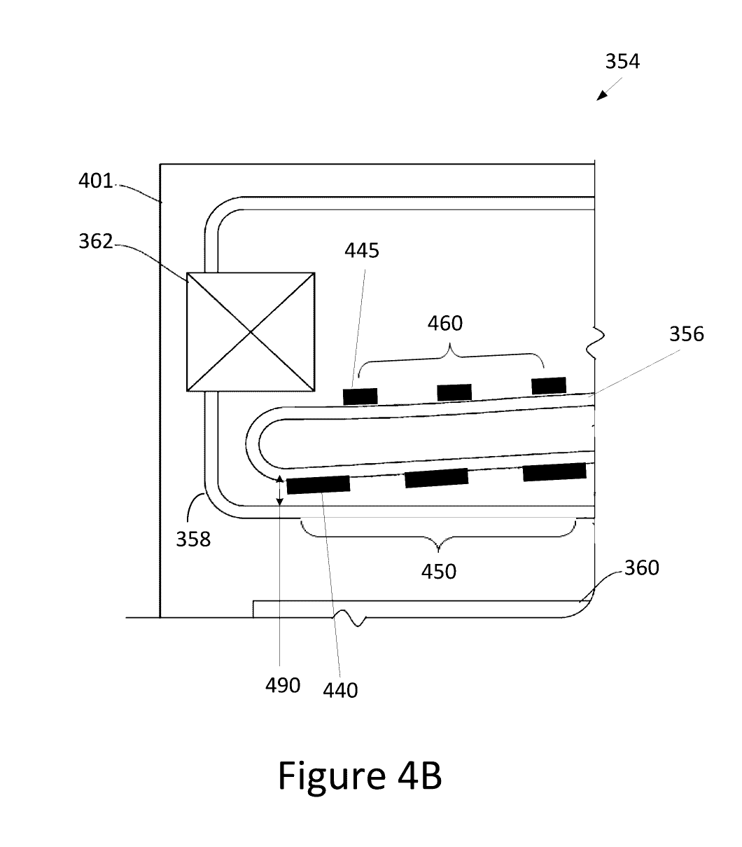

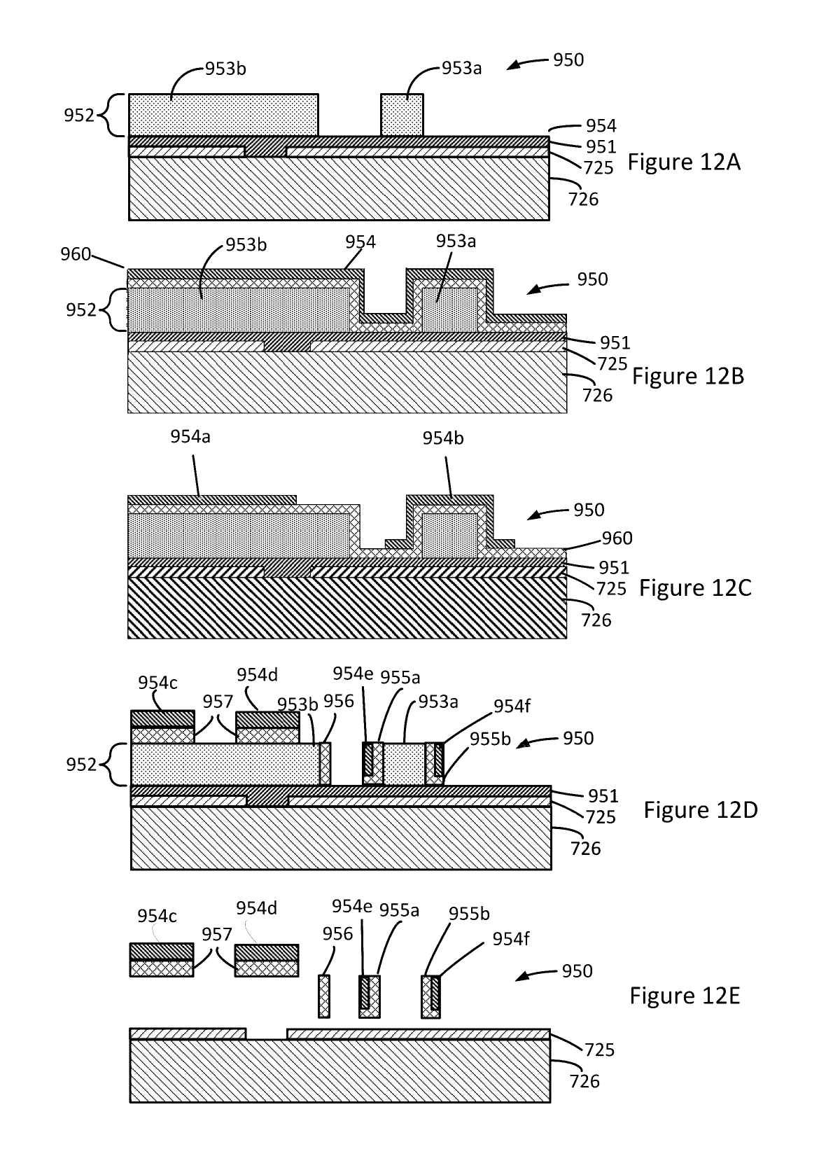

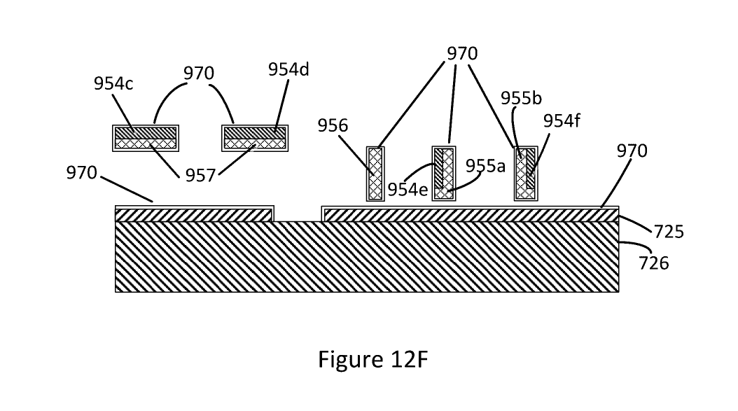

Material stresses resulting from the materials that form and coat the various drive beams and load beams of the actuator can bias the rest position and rest shape of the beams (i.e., the shape and position of the beams when no voltage is applied). In turn, the actuation voltage can be affected by the rest position and rest shape of the beams, and thus depends, in part, on characteristics of a coating applied to the shutter assembly. The actuation voltage can be managed by removing or retaining the coating on the beams in desired positions to adjust the mechanical stresses on the beams. In some implementations, the coating is patterned so that portions of it will be removed to modify one or both of the shape and position of the drive beam. For example, the coating can be patterned into raised tabs having gaps therebetween. The raised tabs are sized, spaced, and positioned to affect a desired rest position and rest shape of the drive beam relative to the load beam. FIGS. 4A and 4B show top views of portions of various example electrostatic actuation assemblies 354 having raised tab areas of different sizes. Specifically, FIG. 4A shows an implementation in which a coating of the dielectric material 404 (shown in FIG. 3) has been patterned to form first raised tabs 410 and second raised tabs 415. FIG. 4A also shows a cross-section designation A-A which is discussed in more detail below with respect to FIGS. 12A-12F. The first raised tabs 410 are on a first surface of the looped drive beam 356 nearest the load beam 358. The load beam 358 extends from the first load anchor 362. The second raised tabs 415 are formed on a second surface of the looped drive beam 356. The first raised tabs 410 are on an opposite side of the loop formed by the looped drive beam 356 than the second raised tabs 415. In the implementation shown in FIG. 4A, each of the first raised tabs 410 and the second raised tabs 415 has a common size. In some implementations, the size of each of the first and second raised tabs 410 and 415 may be in the range of about 3 μm to about 20 μm. In some implementations, the size of each of the first and second raised tabs 410 and 415 may be in the range of about 5 μm to about 12 μm. In addition, there is a common distance between each of the adjacent second raised tabs 415 and each of the adjacent first raised tabs 410. This distance between adjacent raised tabs also may be referred to as pitch. The pitch can range from about 3 μm to about 20 μm.

The first raised tabs 410 are spaced across a first area 420 along the first surface of the looped drive beam 356. The second raised tabs 415 are spaced across a second area 430 along the second surface of the looped drive beam 356. In the implementation shown in FIG. 4A, the size of the first area 420 is different from the size of the second area 430. In particular, the first area 420 is larger than the second area 430. By varying the sizes of the first and second areas 420 and 430 a desired rest position and rest shape of the looped drive beam 356 may be achieved relative to the load beam. Indeed, varying the sizes of the first and second areas 420 and 430 changes the rest position and rest shape of the looped drive beam 356. In an implementation, the desired rest position and rest shape allows a tip gap 490 between the looped drive beam 356 and the load beam 358 to be modified, thereby changing the electrostatic force resulting from a given voltage, and consequently reducing the necessary actuation voltage needed to actuate the actuator. In some implementations, the sizes of the first and second areas 420 and 430 may be further varied depending on the desired rest shape or rest position of the looped drive beam 356. For example, the second area 430 could be larger than the first area 420.

In addition, the number of the first and second raised tabs 410 and 415 also may be modified to change the rest shape or rest position of the looped drive beam 356. For example, in FIG. 4A there are more first raised tabs 410 than second raised tabs 415. Specifically, FIG. 4A shows four of the first raised tabs 410 on the first surface of the looped drive beam 356 and three of the second raised tabs 415 on the second surface of the looped drive beam 356. However, in some implementations, other quantities of the first or second raised tabs 410 or 415 may be used depending on the desired rest shape or rest position of the looped drive beam 356. For example, some implementations may include five of the first raised tabs 410 and three of the second raised tabs 415 or eight of the first raised tabs 410 and five of the second raised tabs 415, and so on.

FIG. 4B shows an implementation in which a coating of the dielectric material 404 (shown in FIG. 3) has been patterned to form third raised tabs 440 and fourth raised tabs 445. The third raised tabs 440 are on a first surface of the looped drive beam 356 nearest the load beam 358. The load beam 358 extends from the first load anchor 362. The fourth raised tabs 445 are formed on a second surface of the looped drive beam 356. The third raised tabs 440 are on an opposite side of the loop formed by the looped drive beam 356 than the fourth raised tabs 445. In the implementation of FIG. 4B, the third raised tabs 440 have a different size than the fourth raised tabs 445. In particular, the third raised tabs 440 are larger than the fourth raised tabs 445. In some implementations, the size of each of the third raised tabs 440 may be in the range of about 4 μm to about 25 μm, and the size of each of the fourth raised tabs 445 may be in the range of about 3 μm to about 20 μm. In some implementations, the size of each of the third raised tabs 440 may be in the range of about 10 μm to about 12 μm, and the size of each of the fourth raised tabs 445 may be in the range of about 5 μm to about 6 μm. In some implementations, the third raised tabs 440 are at least 25%, at least 30%, at least 40%, or at least 50% larger than the fourth raised tabs 445.

In addition, the pitch between the third raised tabs 440 is different than the pitch between the fourth raised tabs 445. Varying the sizes of the particular third and fourth raised tabs 440 and 445 changes the rest position and rest shape of the looped drive beam 356. Likewise, varying the pitch between adjacent raised tabs also changes the rest position and rest shape of the looped drive beam 356. In the implementation shown in FIG. 4B, the pitch between the third raised tabs 440 is smaller than the pitch between the fourth raised tabs 445. In some implementations, the size of the pitch between each of the third raised tabs 440 may be in the range of about 3 μm to about 20 nm, and the size of the pitch between each of the fourth raised tabs 445 may be in the range of about 4 μm to about 25 μm. In addition, in some implementations, the size of the pitch between each of the third raised tabs 440 may be in the range of about 5 μm to about 6 μm, and the size of the pitch between each of the fourth raised tabs 445 may be in the range of about 10 μm to about 12 μm.

Accordingly, the particular size of the raised tabs and the pitch between adjacent raised tabs may be varied depending on the desired rest position and rest shape of the looped drive beam 356. In some implementations, the desired rest position and rest shape allows a tip gap 490 between the looped drive beam 356 and the load beam 358 to be modified, thereby changing the electrostatic force resulting from a given voltage, and consequently reducing the necessary actuation voltage needed to actuate the actuator.

The third raised tabs 440 are spaced across a third area 450 along the first surface of the looped drive beam 356. The fourth raised tabs 445 are spaced across a fourth area 460 along the second surface of the looped drive beam 356. In the implementation shown in FIG. 4B, the size of the third area 450 is different from the size of the fourth area 460. In particular, the third area 450 is larger than the fourth area 460. Similar to the first and second raised tab areas 420 and 430 shown in FIG. 4A, by varying the sizes of the third and fourth areas 450 and 460 a desired rest position and rest shape of the looped drive beam 356 may be achieved relative to the load beam.

In addition, the number of the third and fourth raised tabs 440 and 450 also may be modified to change the rest shape or rest position of the looped drive beam 356. FIG. 4B shows three of the third raised tabs 440 on the first surface of the looped drive beam 356 and three of the fourth raised tabs 445 on the second surface of the looped drive beam 356. However, in some implementations, any number of the third or fourth raised tabs 440 or 445 may be used depending on the desired rest shape or rest position of the looped drive beam 356.

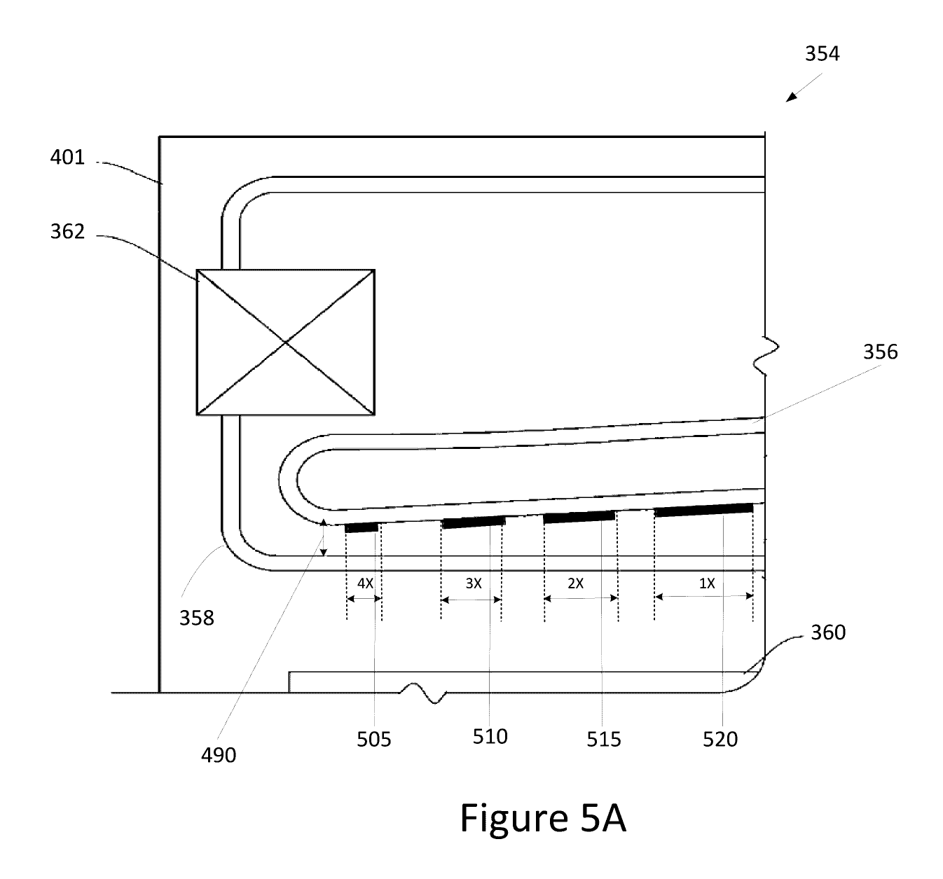

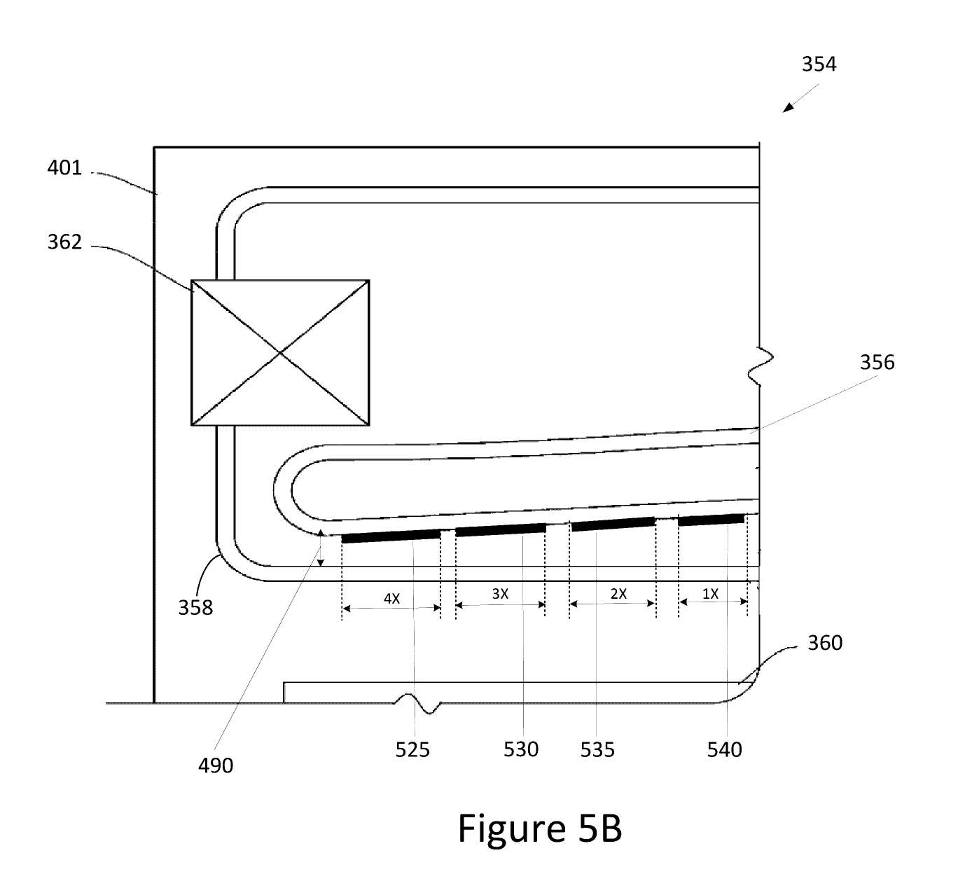

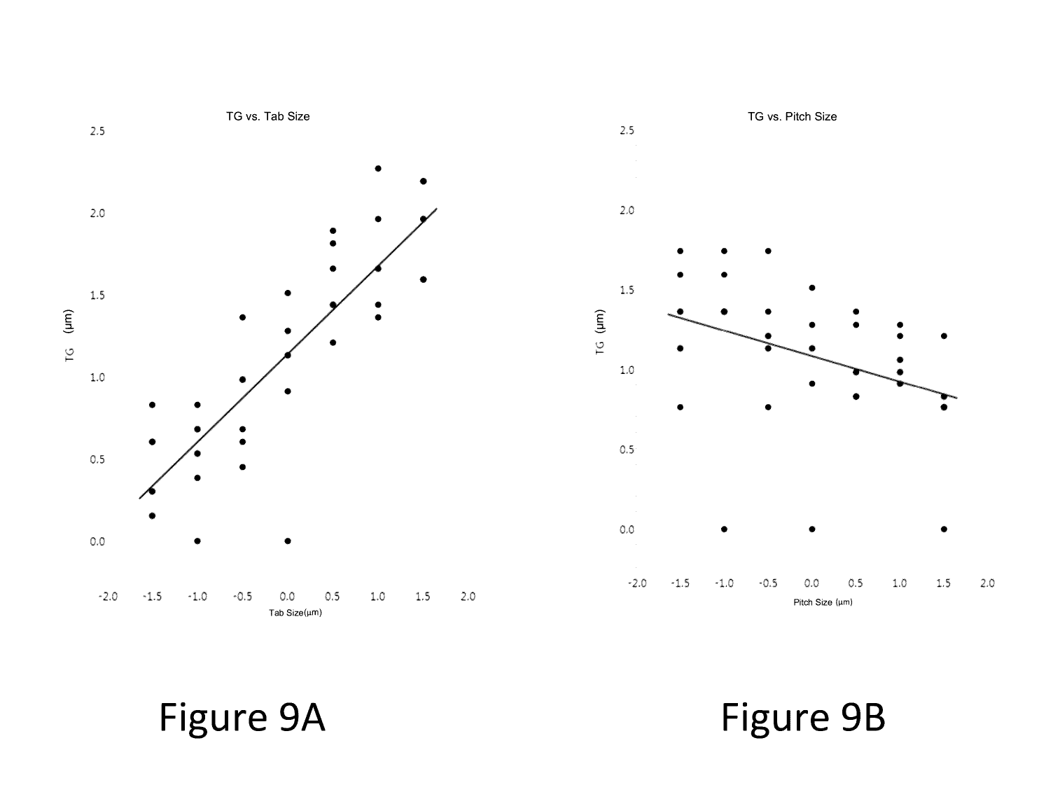

FIGS. 5A and 5B show top views of portions of various example electrostatic actuation assemblies 354 having raised tabs of different sizes. Experimental data showing the effect of changing tab size on tip gap size is shown in FIG. 9A and discussed below. Specifically, FIG. 5A shows an implementation in which a coating of the dielectric material 404 (shown in FIG. 3) has been patterned to form a first raised tab 505, a second raised tab 510, a third raised tab 515, and a fourth raised tab 520. Similarly, FIG. 5B shows an implementation in which a coating of the dielectric material 404 (shown in FIG. 3) has been patterned to form a fifth raised tab 525, a sixth raised tab 530, a seventh raised tab 535, and an eighth raised tab 540. The first raised tab 505, the second raised tab 510, the third raised tab 515, the fourth raised tab 520, the fifth raised tab 525, the sixth raised tab 530, the seventh raised tab 535, and the eighth raised tab 540 are on a first surface of the looped drive beam 356 nearest the load beam 358. The load beam 358 extends from the first load anchor 362. In the implementation shown in FIGS. 5A and 5B, each of the raised tabs has a different size (such as X1-X4) that changes monotonically along the surface of the looped drive beam 356. In some implementations, not all raised tabs have a different size. For example, in some implementations, two or more adjacent raised tabs can have a same size before the sizes of additional raised tabs continues to change monotonically. Accordingly, the size of the raised tabs monotonically changes (such as increases or decreases) along the surface of the looped drive beam 356 such that the sizes of raised tabs positioned nearer a first end of the drive beam are the same or smaller than the size of each successive raised tab positioned nearer a second end of the drive beam. For example, in FIG. 5A, the size of the raised tabs monotonically increases from left to right in that the first raised tab 505 has a size X4 which is smaller than size X3 of the second raised tab 510 which in turn is smaller than size X2 of the third raised tab 515 which in turn is smaller than size X1 of the fourth raised tab 520.

Conversely, in FIG. 5B, the size of the raised tabs monotonically increases from right to left in that the fifth raised tab 525 has a size X4 which is larger than size X3 of the sixth raised tab 530 which in turn is larger than size X2 of the seventh raised tab 535 which in turn is larger than size X1 of the eighth raised tab 540. In some implementations, the size of each of the first-eighth raised tabs 505-540 may be in the range of about 3 μm to about 25 μm. In addition, in some implementations, the size of each of the first-eighth raised tabs 505-540 may be in the range of about 5 μm to about 15 μm, with a pitch between adjacent tabs of about 3 μm to about 20 μm. For example, the first raised tab 505 can have a length along the surface of the looped drive beam 356 of 5 μm, the second raised tab 510 can have a length of 8 μm, the third raised tab 515 can have a length of 11 μm, and the fourth raised tab 520 can have a length of 14 μm, and the pitch between adjacent tabs can be 8 μm.

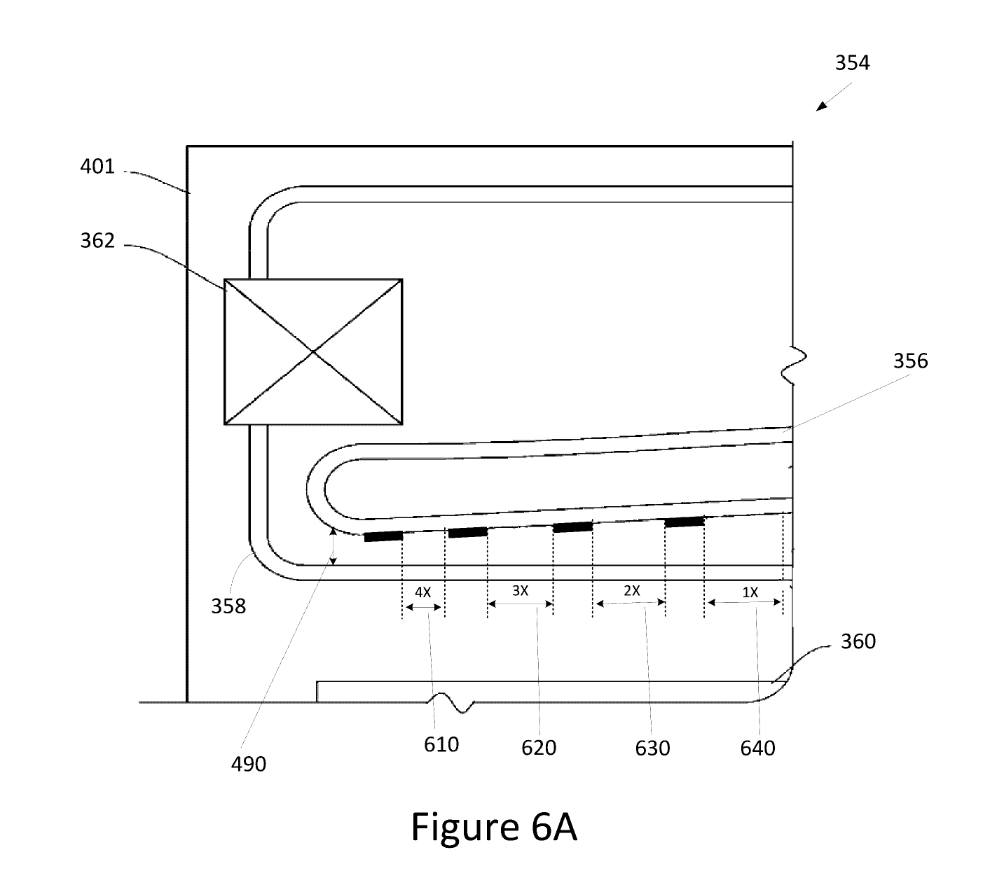

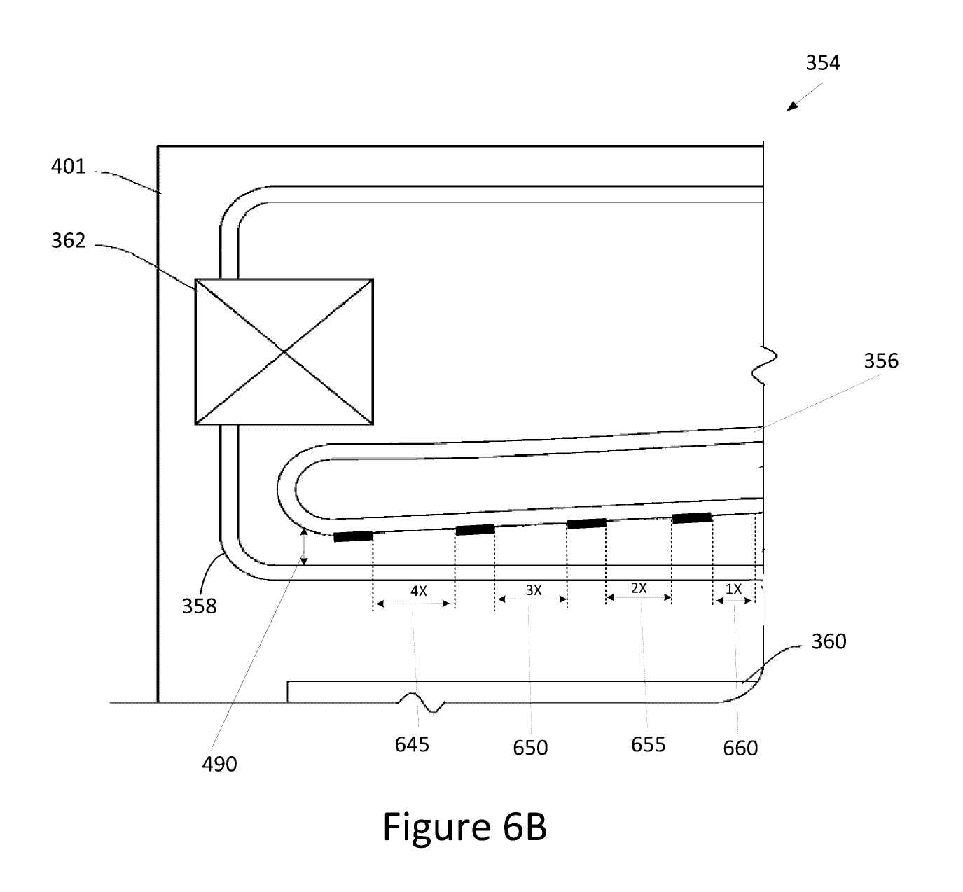

In the implementations shown in FIGS. 5A and 5B, there is a common, constant distance (i.e., pitch) between each of the adjacent raised tabs. In some implementations, the pitch between adjacent pairs of raised tabs also may be varied, as shown in FIGS. 6A and 6B, in addition to or instead of the variation in size of the raised tabs as shown in FIGS. 5A and 5B.

By monotonically varying the sizes of the raised tabs along the surface of a drive beam, a desired rest position and rest shape of the looped drive beam 356 may be achieved relative to the load beam. In some implementations, the desired rest position and rest shape allow a tip gap 490 between the looped drive beam 356 and the load beam 358 to be modified, thereby changing the electrostatic force resulting from a given voltage, and consequently reducing the necessary actuation voltage needed to actuate the actuator. Accordingly, in some implementations, the sizes of the raised tabs may be further varied depending on the desired rest shape or rest position of the looped drive beam 356.

FIGS. 6A and 6B show top views of portions of various example electrostatic actuation assemblies 354 having a varying pitch size between raised tabs 605. Experimental data showing the effect of changing pitch size on tip gap size is shown in FIG. 9B and discussed below. Specifically, FIGS. 6A and 6B show implementations in which a coating of the dielectric material 404 (shown in FIG. 3) has been patterned to form raised tabs 605. The raised tabs 605 are on a first surface of the looped drive beam 356 nearest the load beam 358. The load beam 358 extends from the first load anchor 362. In the implementation shown in FIGS. 6A and 6B, the raised tabs 605 are positioned such that there is a different size pitch between each pair of adjacent tabs. Accordingly, the size of the pitch between adjacent raised tabs 605 monotonically changes (such as increases or decreases) along the surface of the looped drive beam 356 such that the size of the pitch between a pair of raised tabs positioned nearer a first end of the drive beam is the same or smaller than the size of the pitch between each successive pair of raised tabs positioned nearer a second end of the drive beam. For example, in FIG. 6A, the size of the pitch increases from left to right in that pitch 610 between the first pair of raised tabs has a size X4, which is smaller than size X3 of pitch 620 between the second pair of raised tabs, which in turn is smaller than size X2 of pitch 630 between the third pair of raised tabs, which in turn is smaller than size X1 of pitch 640 between a fourth pair of raised tabs.

Conversely, in FIG. 6B, the size of the pitch between pairs of raised tabs decreases from left to right in that pitch 645 has a size X4, which is larger than size X3 of pitch 650, which in turn is larger than size X2 of pitch 655, which in turn is larger than size X1 of pitch 660. In some implementations, the size of each of the raised tabs 605 may be in the range of about 3 μm to about 20 μm, and the pitch between adjacent raised tabs may be in the range of about 3 μm to about 20 μm. In some implementations, the size of each of the raised tabs 605 may be in the range of about 5 μm to about 12 μm, and the pitch between adjacent raised tabs 605 may be in the range of about 4 μm to about 10 μm. For example, each of raised tabs 605 can have a length along the surface of the looped drive beam 356 of 8 μm, and the pitch between the first pair of adjacent raised tabs may be 5 μm, the pitch between the second pair of adjacent raised tabs may be 8 μm, and the pitch between the third pair of adjacent raised tabs may be 12 μm.

In the implementations shown in FIGS. 6A and 6B, each raised tab 605 has a common size. In some implementations, the size of raised tabs also may be varied as shown in FIGS. 5A and 5B in addition to the variation in pitch as shown in FIGS. 6A and 6B.

By monotonically varying the pitch between pairs of adjacent raised tabs of the raised tabs 605, a desired rest position and rest shape of the looped drive beam 356 may be achieved relative to the load beam. In some implementations, the desired rest position and rest shape allows a tip gap 490 between the looped drive beam 356 and the load beam 358 to be modified, thereby changing the electrostatic force resulting from a given voltage, and consequently reducing the necessary actuation voltage needed to actuate the actuator. Accordingly, in some implementations, the size of the pitch between pairs of adjacent raised tabs may be further varied depending on the desired rest shape or rest position of the looped drive beam 356.

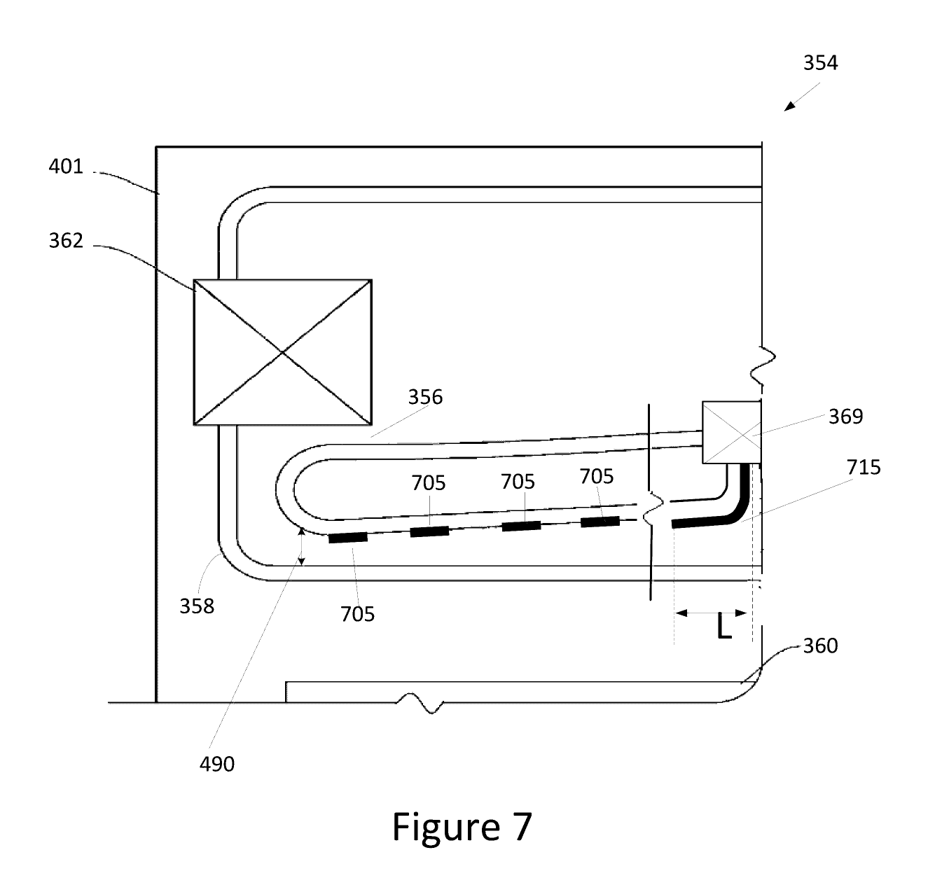

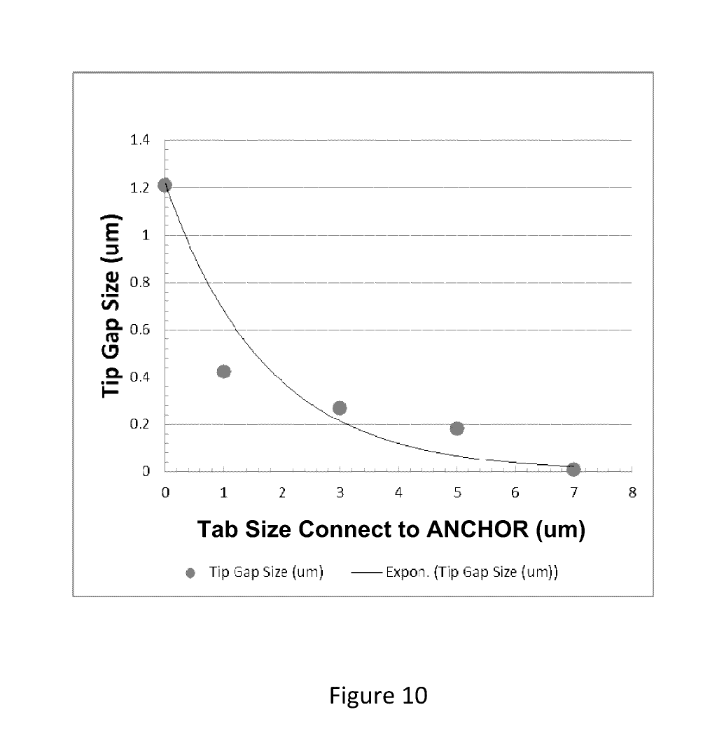

FIG. 7 shows a top view of a portion of an example electrostatic actuation assembly 354 having a raised tab 715 at a curve of the looped drive beam 356. Experimental data showing the effect of changing the length of a raised tab that lies across a curve of a drive beam on tip gap size is shown in FIG. 10 and discussed below. Specifically, FIG. 7 shows an implementation in which a coating of the dielectric material 404 (shown in FIG. 3) has been patterned to form raised tabs 705 and 715. The raised tabs 705 and 715 are on a first surface of the looped drive beam 356 nearest the load beam 358. The load beam 358 extends from the first load anchor 362, and the looped drive beam 356 extends from the first drive anchor 369. Each of raised tabs 705 has a common size. In addition, there is a common pitch size between adjacent raised tabs 705. In some implementations, the size of raised tabs 705 and the pitch therebetween may vary as discussed above at least with respect to FIGS. 5A, 5B, 6A and 6B.

As shown in FIG. 7, the raised tab 715 lies across a curve of the looped drive beam 356 at a point where the looped drive beam 356 curves toward the first drive anchor 369. Positioning the raised tab 715 across the curve of the looped drive beam 356 provides increased control of the rest position and shape of the looped drive beam 356, and in particular provides increased control of the size of the tip gap 490 between load beam 358 and looped drive beam 356. In some implementations, the raised tab 715 has a size L (such as a length of the raised tab 715 along the looped drive beam 356) that is greater than the size of the raised tabs 705. In some implementations, the size (such as the length along the looped drive beam 356) of the raised tab 715 may be varied to modify the rest position and shape of the looped drive beam 356.

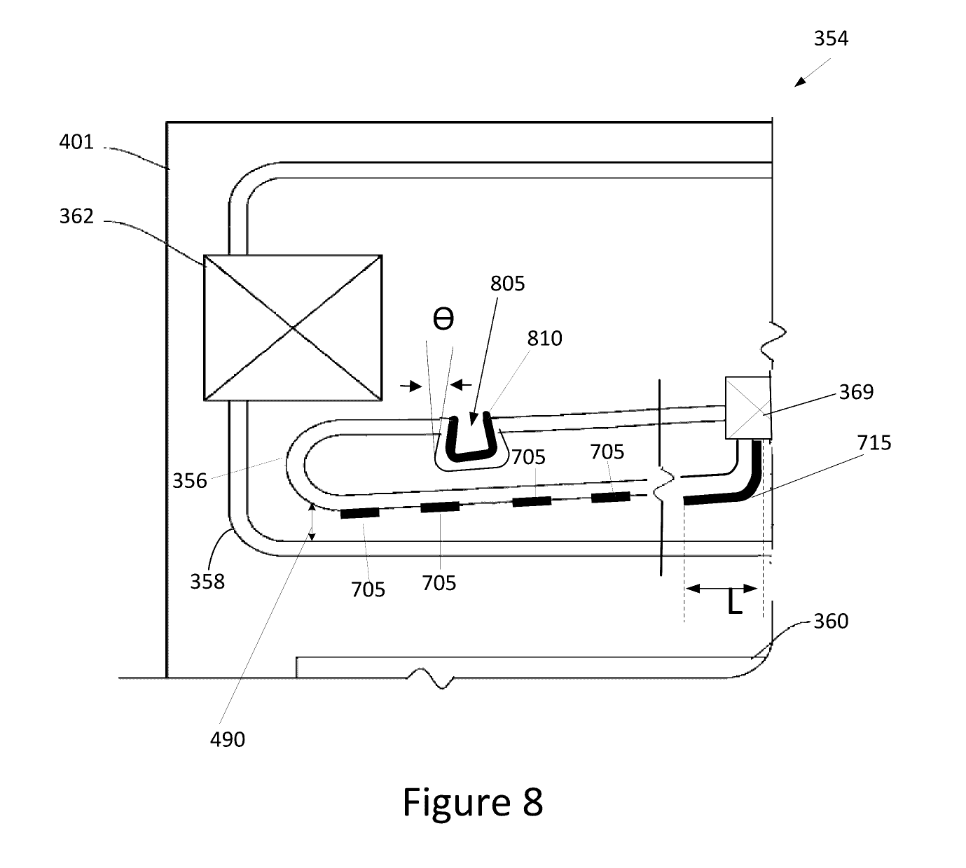

FIG. 8 shows a top view of a portion of an example electrostatic actuation assembly 354 having a raised tab 810 within a concave portion 805 of the looped drive beam 356. Specifically, FIG. 8 shows an implementation in which a coating of the dielectric material 404 (shown in FIG. 3) has been patterned to form the raised tabs 705, 715 and 810. Similar to FIG. 7, the raised tabs 705 and 715 are on a first surface of the looped drive beam 356 nearest the load beam 358, and the raised tab 715 is positioned at a curve of the looped drive beam 356 where the looped drive beam 356 curves toward the first drive anchor 369. The load beam 358 extends from the first load anchor 362, and the looped drive beam 356 extends from the first drive anchor 369.

The drive beam 356 further includes a concave portion 805 in a second surface of the looped drive beam 356 on an opposite side of the loop formed by the looped drive beam 356 as the first surface on which the raised tabs 705 and 715 are positioned. In this way, the concave portion 805 is at a rear side of the looped drive beam 356, i.e., on the side of the looped drive beam 356 furthest from the load beam 358. In some implementations, the concave portion 805 may be formed in any portion of the drive beam 356 depending on one or both of the desired shape and position of the looped drive beam 356. The raised tab 810 is formed within the concave portion 805. The concave portion 805 increases the length of the side of the looped drive beam 356 on which the concave portion 805 is positioned. By increasing the length of that side of the looped drive beam 356, additional material stresses can be generated to affect the rest position and shape of the looped drive beam 356. In some implementations, the concave portion is formed in a manner such that the sidewalls of the concave structure extend at an angle θ back toward the non-concave portions of the looped drive beam 356. In this manner, the size of the surface area of the concave portion and potential size of the raised tab 810 may be increased. In some implementations, the shape of concave portion 805 and size of raised tab 810 may be varied depending on the desired rest shape or rest position of the looped drive beam 356.

FIG. 9A shows a graph of experimental data showing a relationship between tip gap size and various differences in size between adjacent raised tabs. The x-axis, labeled “Tab Size,” depicts the difference in length (in microns) of adjacent raised tabs. The difference in length is shown with respect to a direction from the first anchor 369 to a distal end of the looped drive beam 356 (shown in FIG. 3). Accordingly, “−2.0” shown in FIG. 9A indicates that, for a pair of adjacent raised tabs, the raised tab of the pair nearer the distal end of the drive beam 356 is 2.0 microns smaller than the raised tab of the pair nearer the first drive anchor 369. Likewise, “2.0” shown in FIG. 9A indicates that, for a pair of adjacent raised tabs, the raised tab of the pair nearer the distal end of the looped drive beam 356 is 2.0 microns larger than the raised tab of the pair nearer the first drive anchor 369. The y-axis, labeled “TG,” shows the size of the tip gap (i.e., the nearest distance between a load beam and a drive beam) in microns (nm). As indicated by the graph, the tip gap size increases as the difference in size of adjacent tabs increases and vice versa. As shown in FIG. 9A, a smallest tip gap size is exhibited by implementations in which raised tabs have a larger monotonic increase in size in a direction from the anchor end to the distal end of the drive beam, i.e., such that raised tabs nearer the first drive anchor 369 are much smaller than raised tabs nearer the distal end of the looped drive beam 356.

FIG. 9B shows a graph of experimental data showing a relationship between tip gap size and difference in pitch size between adjacent pairs of raised tabs. The x-axis, labeled “Pitch Size,” depicts the difference in size (in microns) of the pitch between adjacent pairs of raised tabs. The difference in size is shown with respect to a direction from the first drive anchor 369 to a distal end of the looped drive beam 356 (shown in FIG. 3). Accordingly, “−2.0” shown in FIG. 9A indicates that, for two pairs of adjacent raised tabs, the pitch between the pair of adjacent tabs nearer the distal end of the looped drive beam 356 is 2.0 microns smaller than the pitch of the pair of adjacent raised tabs nearer the first drive anchor 369. Likewise, “2.0” shown in FIG. 9B indicates that, for two pairs of adjacent raised tabs, the pitch between the pair of adjacent raised tabs nearer the distal end of the looped drive beam 356 is 2.0 microns larger than the pitch between the pair of adjacent raised tabs nearer the first drive anchor 369. The y-axis, labeled “TG,” shows the size of the tip gap (i.e., the nearest distance between a load beam and a drive beam) in microns. As shown in FIG. 9B, the smallest tip gap size is exhibited by implementations in which the pitch between pairs of adjacent raised tabs have a larger monotonic decrease in size in a direction from the anchor end to the distal end of the drive beam, i.e., such that the distances between adjacent raised tabs nearer the first drive anchor 369 are much smaller than the distances between adjacent raised tabs nearer the distal end of the looped drive beam 356.

FIG. 10 shows a graph of experimental data showing a relationship between tip gap size and length of a raised tab connected to an anchor. An example of such a raised tab is shown FIG. 7 in raised tab 715. The x-axis, labeled “Tab Size Connect to Anchor,” depicts the length (in microns) of a raised tab that is connected to an anchor at a curve of the drive beam. The y-axis, labeled “Tip Gap Size,” shows the size of the tip gap (i.e., the nearest distance between a load beam and a drive beam) in microns. As indicated by the graph, the tip gap size decreases approximately exponentially as the tab size increases.

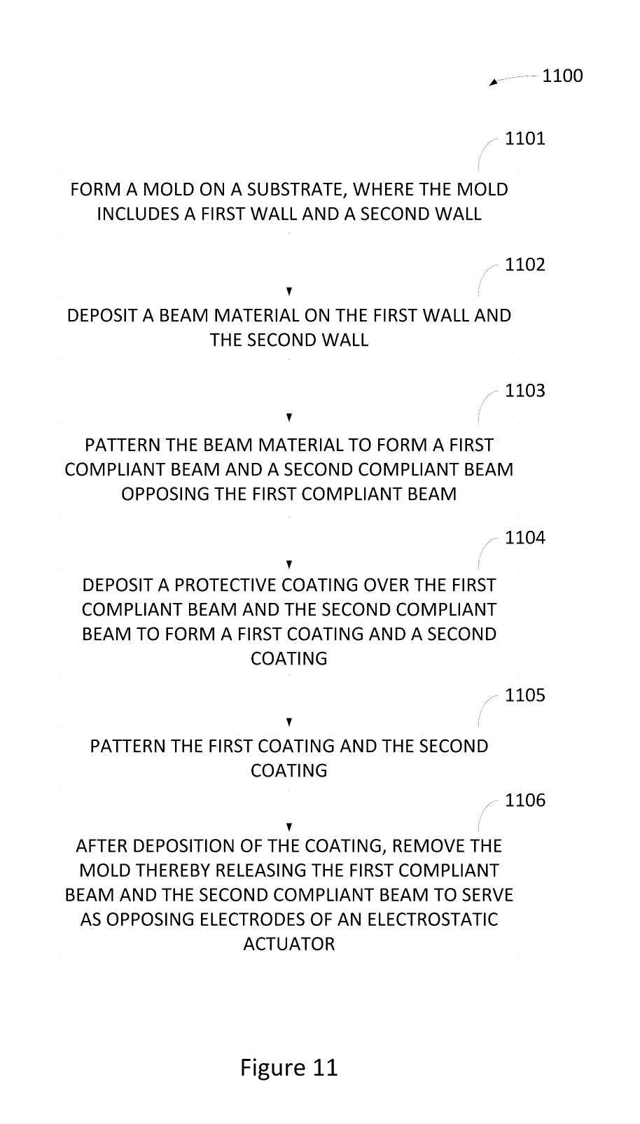

FIG. 11 shows an example flow diagram of a process 1100 for providing a coating over one or more portions of the shutter assembly. The process begins with forming a mold on a substrate where the mold includes a first wall and a second wall (stage 1101).

A structural material is deposited on the first wall and the second wall (stage 1102). The structural material may be composed of one or more layers. In some implementations, the one or more layers include an amorphous silicon layer and a metal layer such as aluminum (Al) or titanium (Ti). A coating is deposited over the structural material to form a first coating and a second coating (stage 1103). In some implementations, a first coating, in the form of a protective dielectric coating, is disposed over a compliant drive beam and a second coating, also in the form of a protective dielectric coating, is disposed over a compliant load beam. In some implementations, the first coating and second coating are different portions of the same layer or layers of material. Materials used for the coating can include, without limitation, silicon nitride (SiNx) or aluminum oxide (Al₂O₃). Other suitable coatings include silicon oxide (SiOx), silicon carbide (SiCx), silicon oxynitride (SiOxNy), niobium oxide (NbOx), hafnium oxide (HfOx), titanium oxide (TiOx), zinc oxide (ZnOx), diamond-like-carbon, multi-layer or composite films using one or more dielectrics materials. The techniques used to deposit the coating can include, without limitation, atomic layer deposition (ALD), chemical vapor deposition (CVD), or plasma-enhanced chemical vapor deposition (PECVD).

The first coating and the second coating are patterned to create desired configurations of one or both of the first and second coating on the structural material thereby forming a plurality of raised tabs that are spaced apart from each other (stage 1104). A variety of suitable patterns are described above in relation to FIGS. 4A-8. For example, one or both of the first and second coatings may be patterned to form a plurality of raised tabs of varying sizes and having varying distances between adjacent raised tabs as discussed above with respect to FIGS. 4A-8. In some other implementations, one or both of the first and second coatings may be patterned to form raised tabs of varying sizes or to form raised tabs having varying distances between adjacent raised tabs as discussed above with respect to FIGS. 4A-8.

The structural material is patterned to form a first compliant beam and a second compliant beam opposing the first compliant beam (stage 1105). For example, a mask is applied over portions of the structural material and remaining portions of the first and second coatings. One or more etchants are then applied to the masked structure. For example, in some implementations, an anisotropic etch is applied, etching away exposed structural material, while substantially leaving the structural material protected by the mask and on the sidewalls of the mold. The remaining structural material forms the shutter, drive beams, and load beams of the shutter assembly.

The mold is removed, thereby releasing the shutter assembly, including the first compliant beam and the second compliant beam to serve as opposing electrodes of an electrostatic actuator (stage 1106).

FIGS. 12A-12F show cross sectional views and isometric views of stages of construction of an example shutter assembly 950. The stages of manufacture are similar to those described with respect to FIG. 11. The cross-section of FIGS. 12A-12F is taken along the axis A-A shown in FIG. 4A. The mold design and the associated stages of manufacture shown in FIGS. 12A-12F are discussed below in detail.

FIG. 12A shows an aperture layer 725 deposited over the substrate 726. The aperture layer 725 has been patterned to form openings, or apertures, within the aperture layer 725. As shown in FIG. 12A, after the patterning of the aperture layer 725, a first sacrificial layer 951 and a second sacrificial layer 952 are deposited over the aperture layer 725. The second sacrificial layer 952 is then patterned to form a mold over which the shutter assembly 950 will be formed. Two resulting raised portions 953a and 953b of the mold are shown in the cross section of FIG. 12A.

After the second sacrificial layer 952 is patterned to form the mold, a structural material 960 is deposited over the first sacrificial layer 951 and the second sacrificial layer 952, as shown in FIG. 12B. The structural material 960 includes one or more layers. In some implementations, the one or more layers include an amorphous silicon (a-Si) layer and a metal layer such as Al or Ti.

In addition, a dielectric material 954 is deposited over the structural material 960, as shown in FIG. 12B. In some implementations, the deposition of the dielectric material 954 is carried out such that the thickness of the dielectric material 954 over various portions of the shutter assembly 950 is between about 10 μm to about 400 μm. The dielectric material 954 can be deposited using a variety of deposition techniques including CVD, PECVD, physical vapor deposition (PVD), ALD, or evaporation. The dielectric material 954 is deposited such that it coats substantially all exposed portions of the mold, including, as shown, the structural material 960. Materials used for the dielectric material 954 can include, without limitation, SiNx or Al₂O₃. Other suitable materials include SiOx, SiCx, SiOxNy, NbOx, HfOx, TiOx, ZnOx, diamond-like-carbon, multi-layer or composite films using one or more dielectrics materials.

As shown in FIG. 12C, the dielectric material 954 is subsequently patterned such that the dielectric material 954 is preserved in a desired pattern on the areas of the structural material 960 that will become the first and second compliant drive beam portions and the shutter. For example, the dielectric portion 954a is preserved over the area of the structural material 960 that will become the shutter, and the dielectric portion 954b is preserved over the area of the structural material 960 that will become the first and second compliant drive beam portions. The dielectric material 954 can be patterned by coating the dielectric material with an etching mask. In some implementations, the etching mask is a layer of photoresist that is photo-patterned, and used as the etching mask. In some implementations, the etching mask can be a hard mask, which can be a thin layer of materials such as silicon dioxide, chromium, aluminum, titanium nitride (TiN), Si, Mo, molybdenum-tungsten (MoW), and molybdenum-chromium (MoCr). The hard mask can be of the thickness of about 0.1 to 1 micron. A photo-pattern is transferred to the hard mask by means of photoresist and wet chemical etching. This can be followed by an isotropic etching process that employs an etchant that selectively removes the dielectric material 954 from all exposed surfaces regardless of orientation of the surface while leaving the structural material 960. After etching of the dielectric material 954, the etching mask is removed leaving the desired pattern of the dielectric material portions 954a and 954b on the sidewalls of the structural material 960. In some implementations, as in the example implementation shown in FIG. 12C, due to the limits of the resolution of the patterning process employed, additional dielectric material may be left across the top of the raised portion 953b, which can be removed in a later anisotropic etching stage.

As shown in FIG. 12D, the structural material 960 and remaining portions of the dielectric material 954 are patterned such that they are preserved over particular surfaces and sidewalls of the mold. For example, the structural material 960 is preserved over sidewalls of the raised mold portion 953a and the raised mold portion 953b. As a result, a compliant drive beam, including a first drive beam portion 955a and a second drive beam portion 955b, is formed over the sidewalls of raised mold portion 953a, and a compliant load beam 956 is formed over the sidewall of the raised mold portion 953b. The structural material 960 is also patterned such that it is preserved over the raised mold portion 953b to form a shutter 957. In addition, dielectric material portions 954e and 954f are preserved over the sidewalls of the structural material 960 that will become the first and second compliant drive beam portions, respectively. In some implementations, a portion of the dielectric material 954 (such as portions 954c and 954d) may be left over the portion of the structural material 960 that will eventually become the shutter in order to protect the shutter from chemical interactions with surrounding fluids and from adhering to nearby surfaces and thereby shorting against such surfaces.

The structural material 960 and remaining portions of the dielectric material 954 can be further patterned. One of a variety of masking materials known to persons having ordinary skill in the art can be deposited over the structural material 960 and remaining dielectric material 954. The mask can be patterned and one or more etchants can be applied to remove exposed portions of the structural material 960 and the remaining portions of the dielectric material 954. For example, by using an anisotropic etch, exposed structural material 960 and the remaining exposed portions of the dielectric material 954 on the sidewalls of the mold can remain substantially intact, while the exposed structural material 960 and the remaining exposed portions of the dielectric material 954 normal to the sidewalls is etched away. Additional components for supporting the shutter 957 and the compliant drive and load beams 955 and 956, such as a drive anchor, a load anchor, and a spring beam, are also formed during this patterning phase, but are not shown in the cross-section of FIG. 12D for illustrative simplicity.

The compliant drive beam 955 and the compliant load beam 956 can be similar in shape and size to the compliant looped drive beam 356 and the compliant load beam 358 shown in FIG. 3, respectively. The first compliant drive beam portion 955a and the second compliant drive beam portion 955b shown in FIG. 12D are formed over two sidewalls of the same raised mold portion 953a, and the compliant load beam 956 is formed over a sidewall of the separate raised mold portion 953b.

After patterning the structural material 960 and remaining portions of the dielectric material 954, the first mold layer 951 (which may also be referred to as an anchor layer) and the second mold layer 952 are removed, as shown in FIG. 12E. This releases the shutter 957 and the compliant drive and load beams 955a, 955b, and 956. As shown in FIG. 12F, a thin passivation layer 970 is deposited over the surfaces of the various components of the shutter assembly 950. The passivation layer 970 coats exposed portions of a-Si to avoid electrical shorting and undesired chemical reactions when the shutter moves in a fluid, such as air, another gas, or a liquid, such as an oil. In some implementations, the passivation layer 970 may have a thickness of between about 25 angstroms and about 100 angstroms, such as approximately 50 angstroms.

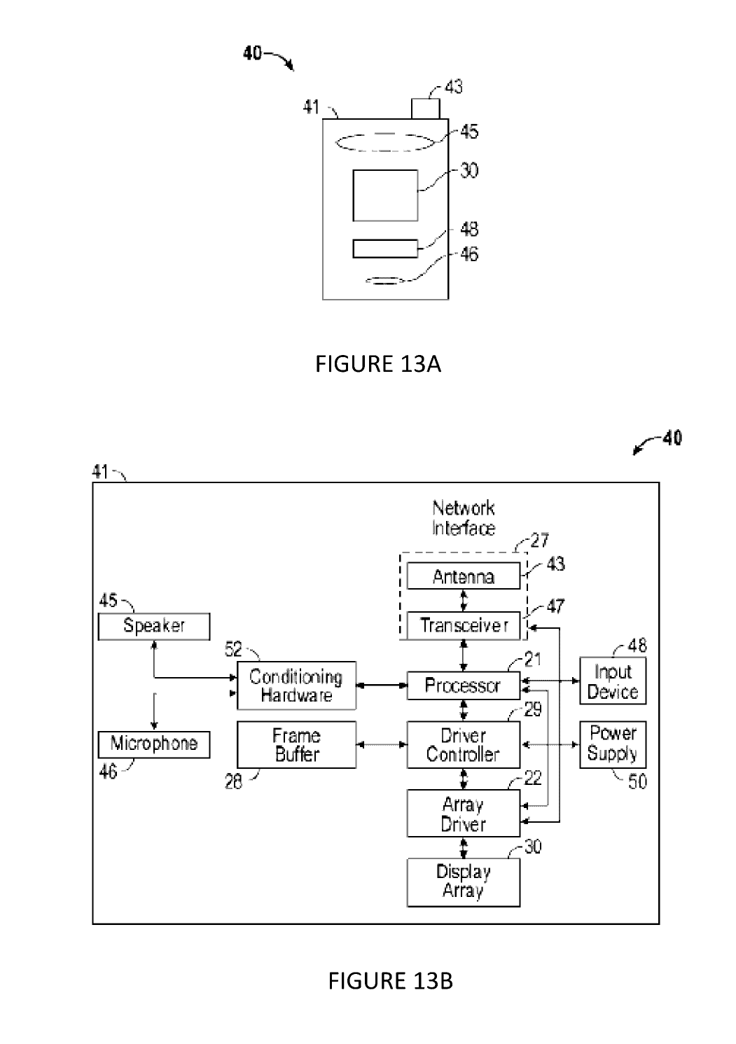

FIGS. 13A and 13B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 13B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 13A can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of one or both of hardware and software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
an electrostatic actuation assembly for controlling a position of a suspended portion of a display element, including:
a load beam;
a drive beam; and
a coating disposed over at least a portion of the drive beam, wherein the coating includes a plurality of raised tabs spaced apart from each other, and wherein at least one of a size of the raised tabs and a pitch between the raised tabs varies along a surface of the drive beam.

2. The apparatus of claim 1, wherein the size of the plurality of raised tabs varies along the surface of the drive beam such that a size of a first raised tab is different from a size of a second raised tab.

3. The apparatus of claim 2, wherein the pitch between each adjacent pair of the plurality of raised tabs is constant.

4. The apparatus of claim 1, wherein the size of the plurality of raised tabs monotonically increases along the surface of the drive beam.

5. The apparatus of claim 1, wherein the size of the plurality of raised tabs increases along the surface of the drive beam such that the size of each raised tab positioned nearer a first end of the drive beam is smaller than the size of each successive raised tab positioned nearer a second end of the drive beam.

6. The apparatus of claim 1, wherein the pitch between the plurality of raised tabs varies along the surface of the drive beam such that a space between a first raised tab and a second raised tab is different from a space between the second raised tab and a third raised tab.

7. The apparatus of claim 6, wherein each raised tab of the plurality of raised tabs has a common size.

8. The apparatus of claim 1, wherein the pitch between the plurality of raised tabs increases along the surface of the drive beam such that a distance between a pair of raised tabs positioned nearer a first end of the drive beam is smaller than a distance between each successive pair of raised tabs positioned nearer a second end of the drive beam.

9. The apparatus of claim 1, wherein the pitch between the plurality of raised tabs monotonically increases along the surface of the drive beam.

10. The apparatus of claim 1, wherein the coating includes a dielectric material.

11. The apparatus of claim 1, wherein the load beam is coupled to a light modulator and to a first anchor, and wherein the drive beam is coupled to a second anchor, and wherein the plurality of raised tabs includes a raised tab that coats a curve of the drive beam at a point where the drive beam curves toward the second anchor.

12. The apparatus of claim 1, wherein the drive beam comprises a concave portion and a raised tab within the concave portion.

13. The apparatus of claim 1, wherein the drive beam is a loop, the loop having a first surface and a second surface, wherein the first surface is a surface of the drive beam nearest the load beam and the second surface is a surface at an opposite side of loop from the first surface, and wherein the plurality of raised tabs are coupled to both the first surface and the second surface.

14. The apparatus of claim 13, wherein the first surface includes a different number of raised tabs than the second surface.

15. The apparatus of claim 1, wherein the size of the raised tabs increases from an anchor end of the drive beam to a distal end of the drive beam, and wherein the pitch between adjacent pairs of raised tabs increases from the distal end of the drive beam to the anchor end of the drive beam.

16. The apparatus of claim 1, further comprising:
a display including:
the display element;
a processor that is capable of communicating with the display and processing image data; and
a memory device that is capable of communicating with the processor.

17. The apparatus of claim 16, the display further including:
a driver circuit capable of sending at least one signal to the display; and
a controller capable of sending at least a portion of the image data to the driver circuit.

18. The apparatus of claim 16, the display further including:
an image source module capable of sending the image data to the processor, wherein the image source module comprises at least one of a receiver, transceiver, and transmitter; and an input device capable of receiving input data and to communicate the input data to the processor.

19. A method for forming an electrostatic actuator, comprising:
forming a mold on a substrate, wherein the mold includes a first wall and a second wall opposing the first wall;
depositing a structural material on the first wall and the second wall;
depositing a coating over at least a portion of the structural material;
patterning at least a portion of the coating to form a plurality of raised tabs that are spaced apart from each other, and wherein at least one of a size of the plurality of raised tabs and a pitch between the plurality of raised tabs varies along a surface of the drive beam;
patterning the structural material to form a load beam and a drive beam opposing the load beam, wherein the plurality of raised tabs are located at least on the drive beam; and
releasing the load beam and the drive beam from the mold.

20. The method of claim 19, wherein patterning the coating includes creating raised tabs having sizes that vary along the surface of the drive beam such that a size of a first raised tab is different from a size of a second raised tab.

21. The method of claim 20, wherein the pitch between each adjacent pair of the plurality of raised tabs is substantially the same.

22. The method of claim 19, wherein the size of the plurality of raised tabs increases along the surface of the drive beam such that the size of each raised tab positioned nearer a first end of the drive beam is smaller than the size of each successive raised tab positioned nearer a second end of the drive beam.

23. The method of claim 19, wherein patterning the coating includes creating raised tabs having sizes that monotonically increase along the surface of the drive beam.

24. The method of claim 19, wherein patterning the coating includes removing portions of the coating to create pairs of raised tabs have pitches that vary along the surface of the drive beam such that a distance between a first raised tab and a second raised tab is different from a distance between the second raised tab and a third raised tab.

25. The method of claim 19, wherein the pitch between the plurality of raised tabs increases along the surface of the drive beam such that a pitch between a pair of raised tabs positioned nearer a first end of the drive beam is smaller than a pitch between each successive pair of raised tabs positioned nearer a second end of the drive beam.

26. The method of claim 25, wherein each raised tab of the plurality of raised tabs has a common size.

27. The method of claim 19, wherein patterning the coating includes creating pairs of adjacent raised tabs having pitches between adjacent raised that that monotonically increase in size along the surface of the drive beam.
